(19) United States
(12) Patent Application Publication
(10) Pub. No.: US 2002/0172508 A1
(43) Pub. Date: Nov. 21, 2002

(54) System and method for multichannel short range media transfer and storage

(76) Inventor: Gabbi Zennou, Haifa (IL)

Correspondence Address: Edward Langer, c o Shiboleth Yisraeli Roberts Zisman & Co, 350 Fifth Avenue 60th Floor, New York, NY, 10118, US

(21) Appl. No.: 10/002,552

(22) Filed: Nov. 1, 2001

Related U.S. Application Data
(60) Provisional application No. 60/292,494, filed on May 21, 2001.

(51) Int. Cl. H04N 5/781

(52) U.S. Cl. 386/125

(57) ABSTRACT

Systems and methods perform simultaneous media transfers, such as video streaming between centralized storage, e.g., a hard drive, that stores data for multiple users, and nodes, in both the record and playback modes. These systems and methods also allow for instant access to live programming and pausing thereof. There is also a central media database, typically implemented in the hard disc(s) of the hard drive, that allows for video storage. High speed broadband Internet access can also be obtained from this system.

### CROSS-REFERENCES TO RELATED APPLICATIONS

This application claims priority from and is related to commonly owned U.S. Provisional Patent Application Ser. No. 60/292,494, filed on May 21, 2001, entitled: SYSTEM AND METHOD FOR MULTICHANNEL SHORT RANGE MEDIA TRANSFER AND STORAGE. This U.S. Provisional Patent Application Ser. No. 60/292,494 is incorporated by reference in its entirety herein.

### TECHNICAL FIELD

The present invention is related video servers, an in particular to short range digital video servers for use with cable systems, and video switches associated therewith.

### BACKGROUND

Digital video technology is rapidly expanding in the consumer market.

Users can now record video in digital format, and can playback the recorded video, through digital video discs (DVDs) or the like. Digital video technology is expected to grow rapidly, in the next few years, as the costs for storage media and video processing continue to decrease. Moreover, the annual digital recording market for consumer applications is expected to grow to more than ten million units by 2004.

Presently, there are systems for digital recording. These systems are single stand-alone units, with a single unit for each television set. These systems allow for recording of programs or portions thereof only.

These systems exhibit drawbacks in that they lack program multi-user data sharing capabilities and lack a central database. The greatest drawback is that they are limited to single extensions and do not support extensions to multiple television sets.

### SUMMARY

The present invention improves on the contemporary art by providing systems and methods for performing simultaneous media transfers, such as video streaming, between centralized storage, e.g., a hard drive, that stores data for multiple users, and nodes, in both the record and playback modes. These systems and methods also allow for instant access to live programming and pausing thereof. There is also a central media database, typically implemented in the hard disc(s) of the hard drive, that allows for video storage. High speed broadband Internet access can also be obtained from this system. Commands on the system from and in some cases between users at any node on the system are transferred over cable, that is typically part of the existing infrastructure of the building or structure, in which the system resides.

There is also disclosed a video server, that supports multiple nodes, typically multiple stations for television or the like. Accordingly, each viewer can have video services (for example, recording of programs and playback of recorded programs, including playback of portions of programs that are simultaneously being recorded), independent of each other viewer of the system. The video streams in the system can be contemporaneous, usually simultaneous, and typically in real time. The video server performs data transfer, by implementing a data transfer process. This process is implemented by dedicated chips, hardware, software or combinations thereof.

A first embodiment of the invention is directed to a media transfer apparatus comprising, at least one storage device and a controller. The controller is configured for bidrectionally transferring video data between a plurality of nodes and the at least one storage device.

Another embodiment of the invention is directed to a data transfer system comprising a system residing on at least one chip (SoC). The system is configured for bidrectionlly transferring digital media data between a plurality of nodes and at least one storage media. The at least one chip, can be for example, a Very Large Scale Integration (VLSI) device.

Another embodiment of the invention is directed to a data transfer system comprising, a controller configured for supporting multiple nodes and configured for providing an interface to centralized storage, for example a hard drive or hard drives. The controller includes switched architecture for supporting bidirectional data streaming between the multiple nodes and the centralized storage.

A fourth embodiment of the invention is directed to a data transfer system comprising a plurality of channels and a server. The server includes a port for receiving data from at least one data source and a controller interfaced to the port and configured for interfacing with centralized storage. The controller is also configured for supporting at least one of; recording of the received data to the centralized storage; and playback of recorded data from the centralized storage, over each of the channels.

A fifth embodiment of the invention is directed to a data transfer system comprising, a controller configured for interfacing with centralized storage, for example, a hard drive or hard drives, and access from any of a plurality of nodes upon receiving at least one signal from one node of the plurality of nodes. The controller is also configured for facilitating data transfer between the nodes and the centralized storage upon the receiving of at least one signal from at least one node of the plurality of nodes. The data transfer between the nodes and the centralized storage can be for example, bidirectional.

A sixth embodiment of the invention is directed to a data transfer device comprising, a system residing on at least one chip (SoC). This SoC is configured for bidrectionlly transferring digital media data between a plurality of nodes and at least one storage media. This storage media can be for example, centralized storage such as a hard drive (single or multiple). The at least one chip can be, for example, Very Large Scale Integration (VLSI) device.

Another embodiment of the invention is directed to a hard disc comprising, a first area and a second area. The first area includes a plurality of divisions configured for being occupied with portions of video data, while the second area includes at least one division defining a table for the divisions of the first area not occupied with portions of video data.

Another embodiment of the invention is directed to a method for transferring video data between plurality of nodes corresponding to channels, and at least one storage device. This method includes monitoring at least one cue for entry of at least one predetermined command, and activating at least one of the plurality of channels in accordance with the at least one predetermined command being entered. Additionally, if the at least one predetermined command has not been entered, a determination if at least one channel is active is made. If at least one channel is determined to be active, video data is then transferred on this at least one active channel.

Still another embodiment of the invention is directed to a method for transferring video data to and from at least one hard disc. This method includes dividing the at least one hard disc into slices, these slices being either occupied with data or free of data. A playback operation is performed for a predetermined recorded segment, this playback operation including, locating a slice of the stored data corresponding to the predetermined recorded segment; transferring the at least one slice of the stored data from the hard disc; or performing a record operation. This record operation includes locating a slice free of data; and transferring a portion of the recorded data to the slice free of data.

Other embodiments of the present invention are described below and shown in the drawing figures.

### BRIEF DESCRIPTION OF THE DRAWINGS

Attention is now directed to the attached drawings, wherein like reference numeral or characters indicate corresponding or like components. In the drawings:

FIGS. 1A and 1B are diagrams of exemplary set ups of embodiments of the present invention;

FIG. 2 is a diagram of the video server in accordance with the present invention;

FIG. 3 is a diagram of the video switch in the server of FIG. 2;

FIG. 4 is a table of specifications for a hard drive usable with the present invention;

FIG. 5 is a diagram detailing disc structures and storage arrangements in accordance with the present invention;

FIG. 6 is a diagram of an alternate embodiment of the video server of the present invention;

FIG. 7 is a diagram detailing operation of a process for the video switch in accordance with an embodiment of the invention;

FIG. 8 is a diagram detailing a subprocess associated with finding the highest priority channel of FIG. 7;

FIG. 9 is a timing diagram of the recording process in accordance with an embodiment of the invention;

FIG. 10 is a timing diagram of the playback process in accordance with an embodiment of the invention; and

FIGS. 11A and 11B are a flow diagram of operation of the FIFO buffers in accordance with the present invention.

### DETAILED DESCRIPTION OF THE DRAWINGS

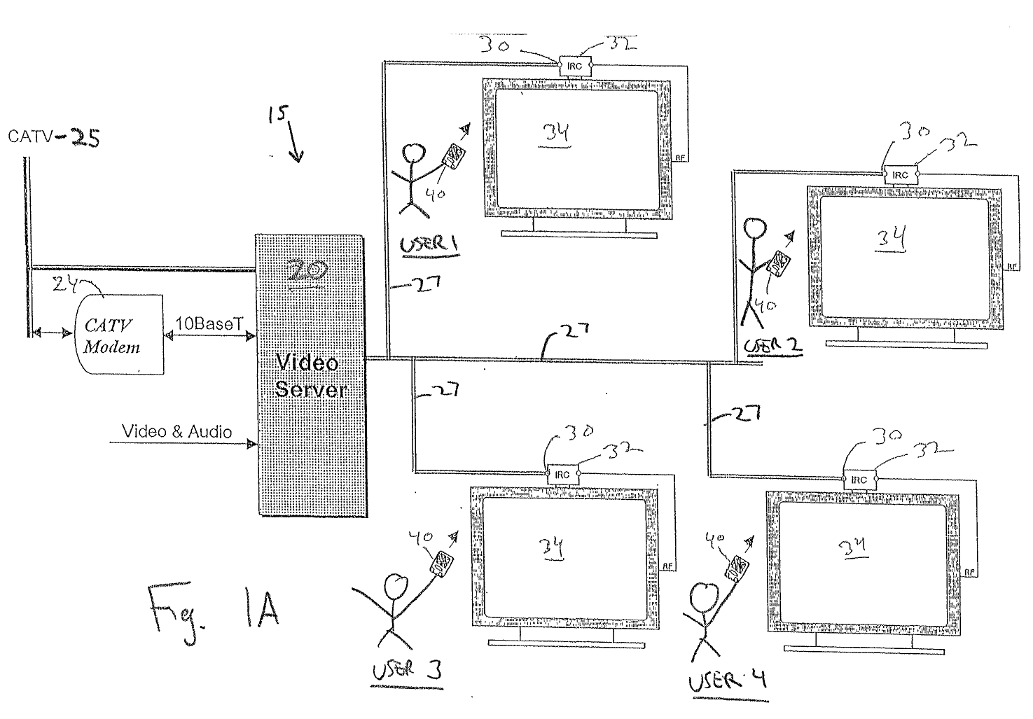

FIG. 1A shows the present invention with an exemplary system 15. The server 20 of the present invention has been connected to a cable modem 24 (that receives/sends transmissions to a cable provider CATV 25). The connection is typically with coaxial cable 27 or other suitable lines (typically, the system of coaxial cable and/or lines already in the premises) to nodes 30, in a bussed configuration. These nodes 30 typically interface with stations 32 (for example, Infrared coaxial cable converters, that may be set-top boxes), that connect to televisions 34, display screens, video monitors, or the like, for providing the received data, typically as video feeds. The stations 32 typically communicate with the televisions 34 by wired or wireless (e.g. radio frequency (RF)) links. The stations 32 are typically controlled by remote controllers 40, other Infrared (IR) controllers or the like.

This cable modem 24, can also be any suitable high speed modem for connecting to a data source, and can also provide linking to the Internet or other network, to a Personal Computer (PC) workstation or other machine (not shown) sitting on or along the coaxial cable 27 or lines (thus defining another node 30), or the already existing nodes 30. Since a cable modem 24 is used in this system 15, the cable provider 25, who provides the video stream to the server 20, can also (and typically will) be the Internet service provider (ISP). Accordingly, the Internet or other network may be accessed through this system 15.

Alternately, the server 20 can be bypassed by the cable modem 24. In this case, the system will function as detailed below, except that recording of live programming will not be able to be performed.

FIG. 1B is similar to FIG. 1A, but shows a system 15′ with nodes 30, supporting stations 32 for televisions 34 in a star configuration. Here, each node 30 connects directly to the server 20, allowing for privacy of each user (indicated as Users 1-4). All other details of the system 15′ are similar to those of the system 15, and are in accordance with the identically numbered components detailed above and below.

Both systems 15, 15′ of FIGS. 1A and 1B are such that they can be fitted into existing cabling of a premises, such as a building, structure, house, residence, or the like. The system can also employ combinations of direct and bussed connections between the video server 20 and the various nodes 30. While four nodes are shown, this is exemplary only, as any number of nodes (for any number of users) is permissible in accordance with the principles of the invention, as described herein.

Turning also to FIG. 2, the video server 20 is formed of a main board 60, that supports a main or host processor 61 and a video switch 62. The main board 60 connects to extension boards 64a-64d. Each extension board defines a channel, corresponding to each node 30, for the respective user (users 1-4, as shown). Each extension board 64a-64d communicates with the main board 60 (and the main processor 61 and video switch 62 thereon) typically by data links, these data links including for example, Audio/Video links 65a-65d (that connect to the video switch 62 via line 65x) and control links 65a′-65d′ that connect to the main processor 61 via line 65x′).

These extension boards 64a-64d, each typically include an encoder 66a-66d (FIG. 3) and a decoder 67a-67d (FIG. 3), for accommodating the respective record and playback video streams for each channel (node 30), and are coupled with the main processor 61. This arrangement on an encoder and decoder for each channel (or node 30), allows a user (here, any of users 1-4) to perform playback and recording operations at the same time (for example, contemporaneously or simultaneously), with the playback operation including playback of portions of programs that are simultaneously being recorded. The extension boards 64a-64d are connected to the coaxial cables 27 or lines of the cabling system, whereby each extension board 64a-64d supports a corresponding node 30, here, stations 32 for televisions 34 in the system 15.

A line 68 extends from the coaxial cables 27 or lines to a controller 69, that couples this line 68 with the main processor 61. This line 68 carries commands from the remote controllers 40 to the main processor 61, the operation of which is detailed below.

The main board 60, via the video switch 62, also couples to centralized storage, typically single or multiple storage media, and for example, a hard drive 70 (detailed below) and a storage media buffer 72. The storage media buffer 72 is typically a single buffer that is divided into portions, here portions dedicated to memory or memory buffers for playback 73a-73d (FIG. 3) and recording 74a-74d (FIG. 3), one of each type of memory buffer corresponding to the respective channels (via the respective extension boards 64a-64d). The memory buffers 73a-73d and 74a-74d are for example 2 MB in size and for example, SDRAM (synchronous DRAM) memory, with other sizes and memory types also suitable. There is also a power supply 80, for example, adapted for AC current, that provides power to all aforementioned components of the video server 20, through the main board 60.

A series of external interfaces 84 extend from the main board 60. These external interfaces provide data networking via external modems, such as the cable modem 24 (detailed above), as well as standard cable television channels. They may also provide Internet and other network connections, LAN connections, universal serial bus (USB), modem, telephony connections.

Turning further to FIG. 3, the video switch 62 is shown in detail (along with some other components of the system 15). This video switch 62 is typically a designed as a “System on a Chip” solution (SoC), and for example, can be a Very Large Scale Integration (VLSI) chip or chips (device or devices). It is programmable and has a switched architecture that performs and manages data transfers, typically bidirectional data transfers, of for example, digital media data (audio data, video data, and control data etc.) between nodes (users typically controlling their video devices, such as televisions 34 and stations 32 at these nodes) and centralized storage. For example, the switched architecture allows for control of data transfers between several bi-directional Moving Picture Experts Group-2 (MPEG-2) streaming video users (here, for example, users 1-4) and centralized storage, for example, the hard drive 70.

The video switch 62 is controlled by the main or host processor 61, through a serial interface 85. There is also a program memory bus (not shown) that connects the video switch 62 to an external program memory (not shown) on the main board 60. This external program memory is typically flash or SDRAM type memory.

The video switch 62 is formed by the coupling of a data transfer controller (DTC) 90 positioned intermediate a storage media interface (SMI) 94, for example, an Advanced Technology Attachment (ATA) controller, and a processor 95, for example, a Reduced Instruction Set Computer (RISC) processor. The SMI 94 and processor 95 typically couple to the data transfer controller 90, each by a bus 96, 97 or the like, and for example, each via a 32 bit bus. The data transfer controller 90 is also coupled to the buffers 100a-100d, 101a-101d, typically First In First Out (FIFO) buffers or FIFOs, typically by a bus system 104, for example, via a 32 bit bus system. The data transfer controller 90 is also coupled to the storage media buffer 72, typically via a bus 107, for example, a 32 bit media buffer bus.

The data transfer controller 90 controls all streaming and other data flows within the video switch 62. The data flows controlled by the data transfer controller 90 include data flows between the respective encoders 66a-66d and the corresponding record media 74a-74d, for each channel, through the respective FIFOs 100a-100d; and between the respective decoders 67a-67d and corresponding playback media buffers 73a-73d, for each channel, through the respective FIFOS 101a-101d.

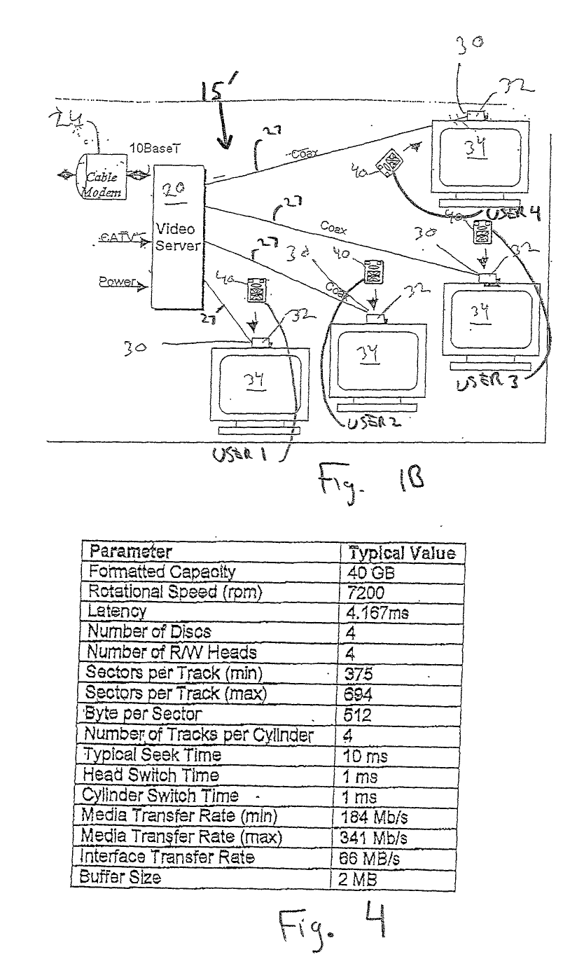

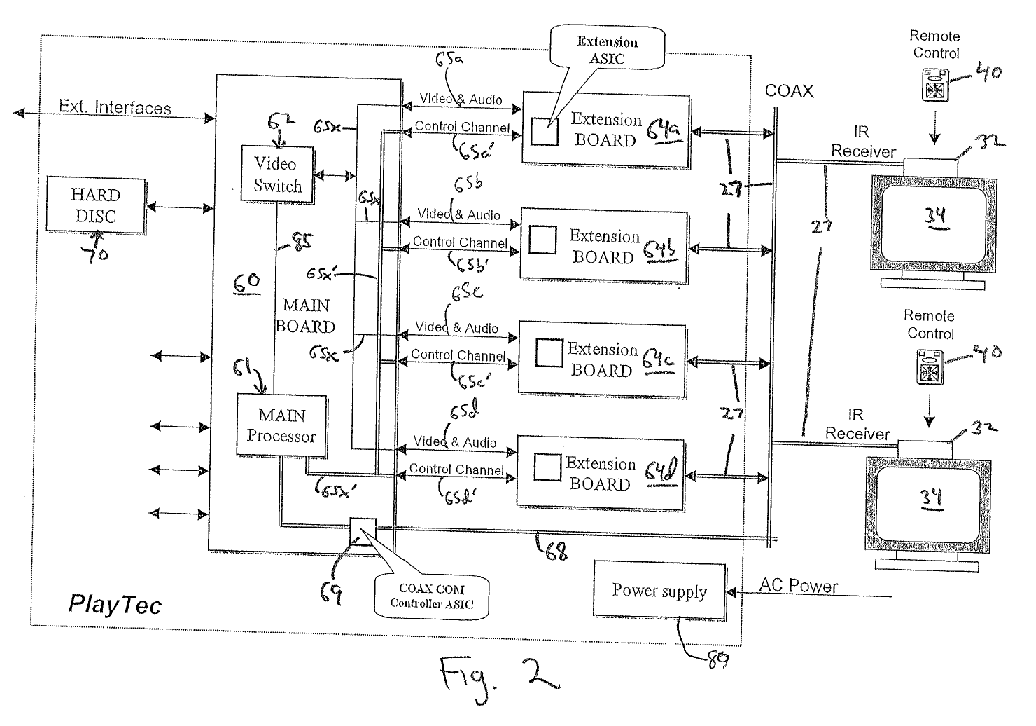

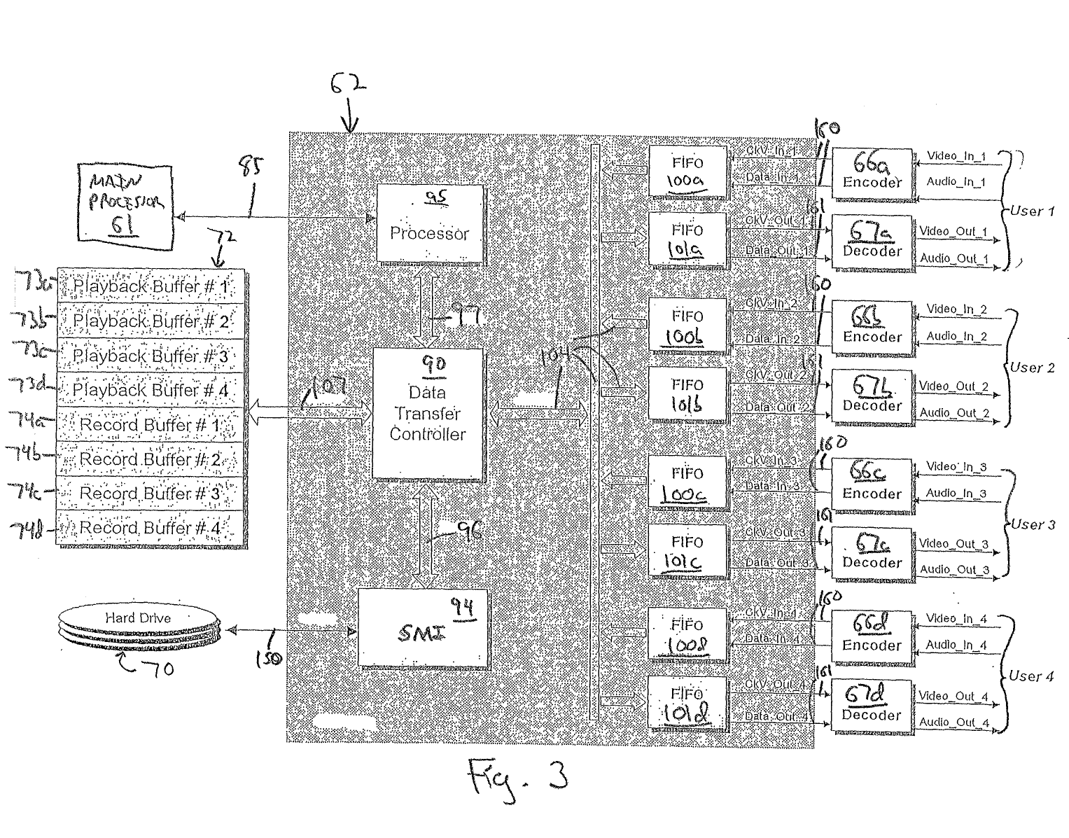

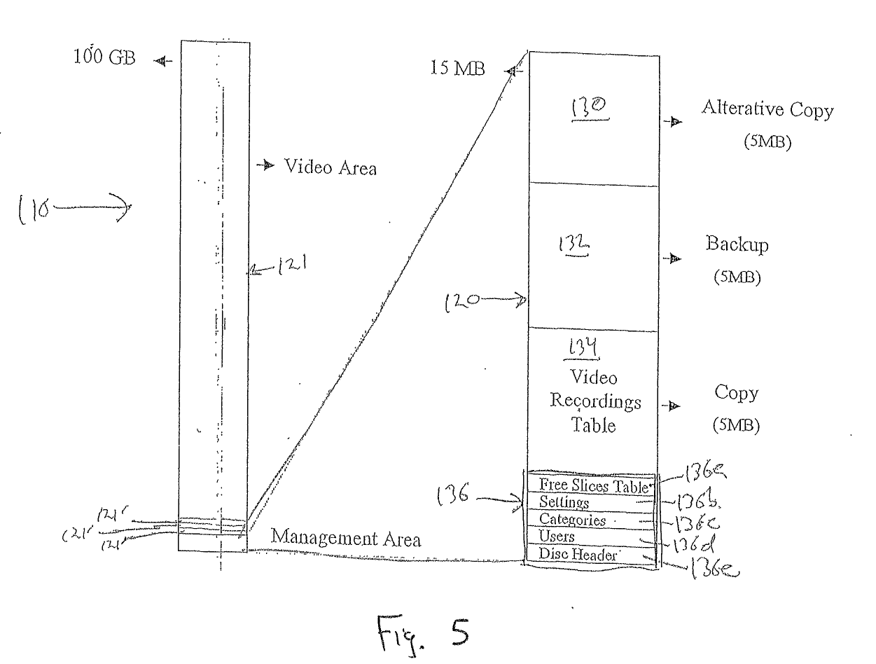

The hard drive 70 typically includes at least one, and typically, multiple hard discs, for magnetic, optical, semiconductor or other source of electrical signals, storage, coupled with memory or other storage media. The hard drive 70, for example, can be in accordance with the specifications detailed in FIG. 4. The hard drive 70 can store, multiple forms of media, for example, recorded programming (movies, programs, etc.), images (photographs, documents, etc.), other videos (home movies, etc.) and other media (web pages, audio clips, etc.).

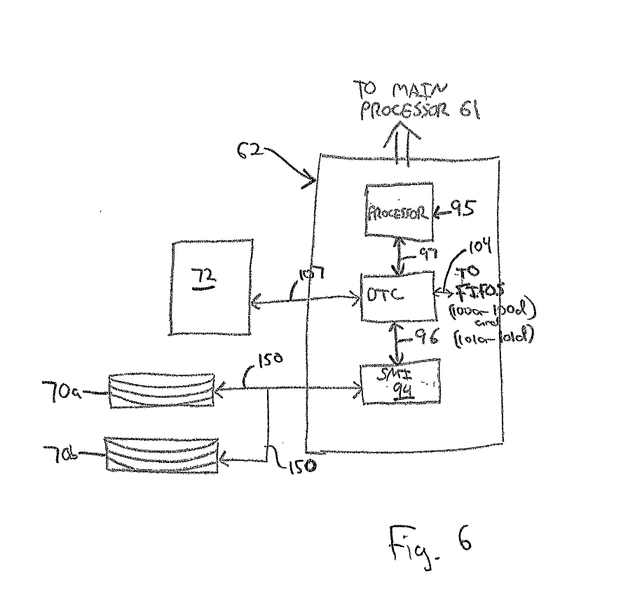

Turning also to FIG. 5, there is detailed the arrangement for the hard disc 110 in the hard drive 70. This hard disc 110 is, for example, able to store 100 gigabytes (GB) of data. It is typically divided into two major sections, a management section 120 and a storage (Video area) section 121. Typical allocations for hard disc 110 may be for example, that the management section 120 is approximately 15 megabytes (MB), with the remainder of disc space (here, the remainder of the 100 GB) going to the storage section 121.

Specifically, the management section 120 is in four subsections 130, 132, 134, 136, three subsections 130, 132, 134 of approximately 5 megabytes (MB) each, and a fourth subsection 136 of negligible size. A first subsection 130 is for alternative copy, that functions as a secondary backup, backing up the backup of the second subsection 132. The second subsection 132 is the primary backup, while a third subsection 134 is typically for maintaining a list of all recorded programs in a video recordings table.

The fourth subsection 136 includes tables 136a-136e. These tables include a free slices table 136a, for indicating the slices 121′ in the storage section 121 that are free, a settings table 136b, for general settings of the system, for example, user interface language, channel settings, privileges/lock outs, and a categories table 136c. In this categories table 136c, the recorded programs and other recorded media (above) in the video recordings table of the third subsection 134 are classified by subject, for example, the recorded programs may be classified as comedy, drama, sports, etc. There is also a users table 136d, for maintaining user names, passwords, codes, favorite channels, etc., and disc header 136e, that includes disc identification information, software versions, disc sizes, pointers where other tables are placed on the disc 110.

The storage area 121 is divided into slices 121′, with each slice being approximately 1 megabyte. This slice arrangement minimizes mechanical seek times to one seek per one megabyte of data and thus allows for the rapid operation of the system.

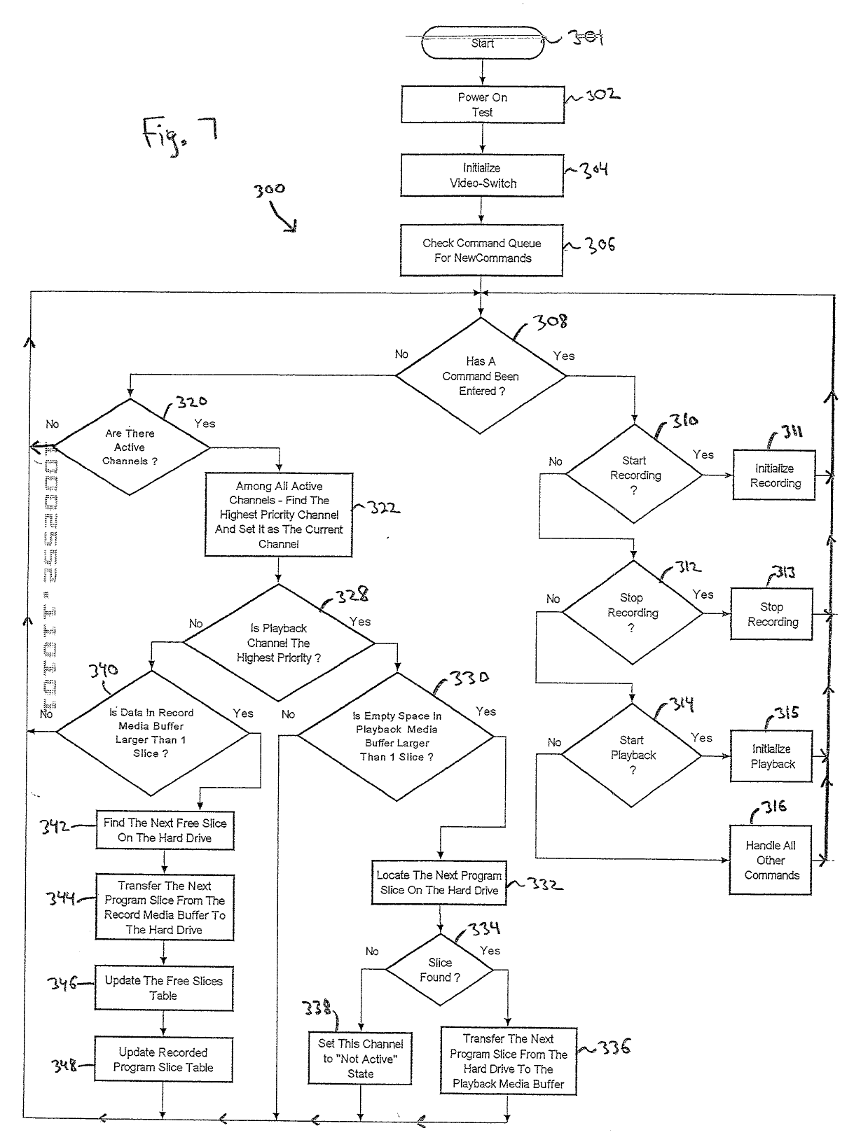

Turning back to FIG. 3, the SMI 94, functions to control all data transfers between the hard drive 70 and the video switch 62, particularly the data transfer controller 90. It is typically coupled to the hard drive 70, via a bus 150, for example, an Ultra ATA Bus (typically 16 bits). The data transfers typically include retrieving the recorded data from the hard drive 70 and recording new data on the hard drive 70. The SMI 94 can also be configured for use with multiple, typically two hard drives, such as the embodiment of the invention shown in FIG. 6 and detailed below.

The processor 95 can be for example, a Reduced Instruction Set Computer (RISC) processor. It functions to execute the processes, for example algorithms or the like, performed by the video switch 62. An exemplary process performed by the RISC processor 95 is detailed in below and processes executed by this RISC processor 95 are also detailed with respect to the data transfer controller 90 below.

The buffers, here FIFOs 100a-100d (input or RECORD) and 101a-101d (output or PLAY) are used for small amounts, for example, a capacity of 32 bytes, of data storage. One input and one output buffer correspond to each channel that supports each node (Users 1-4 in FIG. 3), for the respective output (PLAY) stream and the input (RECORD) stream. With each channel having an input (RECORD) buffer and an output (PLAY) buffer, a single channel can be playing and recording at the same time (in accordance with the exemplary process detailed below).

This serial interface 85 is typically a channel that extends from the processor 95 to the main processor 61. The serial interface 85 is typically a high speed serial communication channel, such as a channel in accordance with the RS-422 standard, but could also be an I2C (Phillips Electronics of The Netherlands) channel or the like. This channel is used to program the processor 95 and the data transfer controller 90 with the process to be implemented, and is also used for delivery of media streaming commands thereto.

There are also media stream inputs 160. Each one of these inputs 160 is used for transferring media data to be recorded on the hard drive 70. Similarly, there are media stream outputs 161. Each one of these outputs is used for transferring recorded media data from the hard drive 70 to one of the media clients, represented in FIG. 3 by Users 1-4.

The actual number of the inputs 160 and outputs 161 depends on the specific implementation of the video switch 62. For example, a video switch implementation that provides four media stream inputs and four media stream outputs, can support real time high quality MPEG-2 video streaming on all channels using a low cost ULTRA ATA Integrated Drive Electronics (IDE) hard drive.

The data transfer controller 90 controls all streaming data flows (and other data flow) that take place within the video switch 62. Data paths controlled by the data transfer controller, for example, may include: Input FIFO 100a-100d to the external media buffers 74a-74d (used for RECORD); external media buffers 74a-74d to the hard drive 70 (used for RECORD); the hard drive 70 to the external media buffers 73a-73d (used for PLAY or PLAYBACK); external media buffers 73a-73d to output FIFOs 101a-101d (used for PLAY); processor 95 to the hard drive 70, and vice versa (both for storage management); and processor 95 to external media buffers 73a-73d, 74a-74d, and vice versa (both for memory tests). An exemplary operation of the data transfer controller 90 is detailed below.

Alternate embodiments of the video server 20′, such as that shown in FIG. 6, include two hard drives (hard discs) 70a, 70b (similar to hard drive 70). This video server 20′ is similar in all aspects and operation to the video server 20 detailed above, except where indicated. Therefore, similar components are in accordance with those described above, and will not be described for video server 20′. The hard drives 70a, 70b are coupled to the SMI 94, typically via the bus 150. Typically, the hard drives 70a, 70b are configured such that the first hard drive 70a is a main or primary hard drive, while the second hard drive 70b is a secondary hard drive.

In an exemplary operation of the server 20, user commands from the various stations 30, typically entered through each user's (user 1-4 as shown) remote controller 40, are communicated over line 68 to the main or host processor 61 in the main board 60. The main processor 61 then analyzes the signal corresponding to the entered command, and transforms it into a series of commands, any number of which (including zero) may go to the video switch 62, and any number of which (including zero) that may go to portions of the server 20, outside of the video switch 62. Of these commands outside of the video switch 62, of particular interest here are commands that the main processor sends to the encoders 66a-66d and decoders 67a-67d.

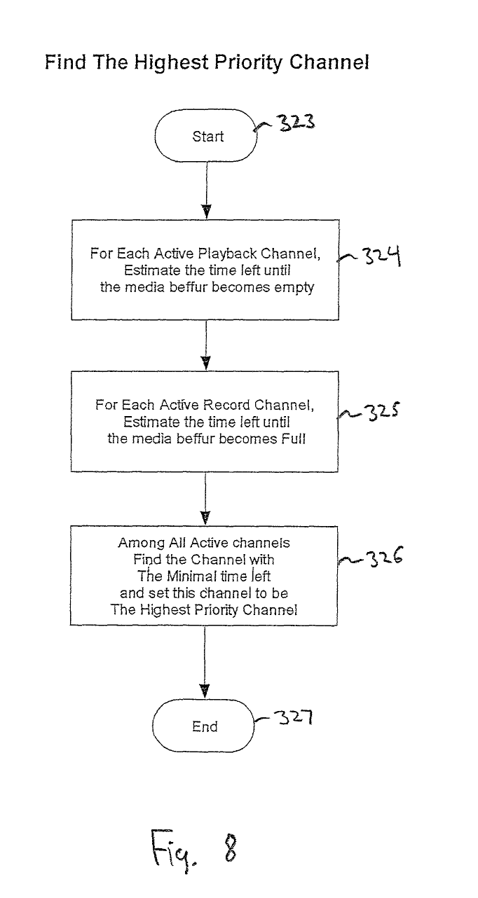

Turning now to FIG. 7, an exemplary operation of the video switch 62 is detailed as a process in the form of a flow diagram. This process performs two major tasks, typically contemporaneously and in many cases simultaneously. These tasks include entering streaming commands into the system, and processing these entered commands.

Initially, the main processor 61 typically provides the video switch 62 with three media streaming commands, corresponding to the user entered functions of START RECORDING, STOP RECORDING and START PLAYBACK, along with additional commands. For description purposes, the three media streaming commands to the video switch 62 will also be referred to by these names. Similarly, commands outside of the video switch 62 (described below) will also be referred to as per their user entered function names. These additional commands, for example, may include commands such as, write to the hard disc(s) of the hard drive 70, read from the hard disc(s) of the hard drive 70, copy within the hard disc(s) of the hard drive 70, check for compatibility of additional hard discs or other system components, perform a self-test, etc.

The video switch 62 will perform these three media streaming commands, along with additional commands, as sent from the main processor 61, through the serial interface (e.g., high speed communication channel) 85. When a media streaming command is sent to the video switch 62, it is typically accompanied by command parameters. These parameters typically specify the streaming channel, to which a particular user is connected, program identifications on the hard disc(s) of the hard drive 70, etc.

When a command arrives at the video switch 62, the communication channel generates a hardware interrupt. As a result, an interrupt handler receives the command, and all of its parameters, and stores it in a command queue. The command queue (typically on the main board 60 but not shown) stores commands, until the processor 95 of the video switch 62 is ready for them. For description purposes, each command received at the command queue will be considered as a new command.

Initially, the process 300 starts at block 301, and a Power-On Test occurs at block 302. This power-on test is a self-test by the video switch, with its results reported to the main processor 61. In this manner, the main processor 61 confirms normal operation of the video switch 62. Otherwise, if the self-test results are unsatisfactory, the main processor 61 provides a signal, typically displayed on the user's screen 34 as an error message, that the system is down or not functioning properly.

The process now moves to block 304, where the video switch 62 is initialized. For example, at minimum, in this initialization step, the status of all channels is set to “inactive”.

With initialization complete, the processor 95 requests new commands, at block 306. It is then determined if a new command has been entered into the processor 95 from the command queue, at block 308. if a new command has been entered into the processor 95 from the command queue, the new command is processed at blocks of the 310 series. If no new command has been entered into the system, the “active” channels are processed at blocks of the 320, 330 and 340 series.

If a new command has been entered into the system, it is determined if this command is to START RECORDING, at block 310. If yes, the record function is initialized for the requesting channel, at block 311. This initialization process includes, locating a free slice (using the free slice table 136), creating and initializing a program header on the requisite hard disc of the hard drive 70, on the free slice that has been located, marking this free slice as occupied (in the free slice table), and changing the status of the requesting channel from “inactive” to “active”. It also includes assigning a program identification to this recording and reports it to the main processor 61. The process then returns to block 308.

If this command is not the START RECORDING command, it is determined if this command is the STOP RECORDING, at block 312. If yes, the a STOP process occurs at block 313. This process includes, changing the status for the requesting channel from “active” to “inactive”, flushing any remaining data from the respective record media buffer 74a-74d to the hard drive 70, and updating the program header on the requisite hard disc of the hard drive 70. The process then returns to block 308.

If this command is not the STOP RECORDING command, it is determined if this command is to START PLAYBACK, at block 314. If yes, the playback function is initialized for the requesting channel, at block 315. This initialization process includes, loading the program header from the hard drive to the memory, changing the status of the requesting channel from “inactive” to “active”. The process then returns to block 308.

If this command is not the START PLAYBACK command, it is one or more additional commands, represented by block 316. For example, these additional commands such as write to the requisite hard disc of the hard drive 70, read from the hard disc, copy within the hard disc, check for compatibility of additional hard discs or other system components, perform a self-test, etc. Once these additional commands are executed, the process returns to block 308.

As stated above, if a command has not been entered into the system, at block 308, the process moves to block 320, where it is determined if there are any active channels. If no, the process returns to block 308. If yes, the process moves to block 322, where processing begins on the “active” channels.

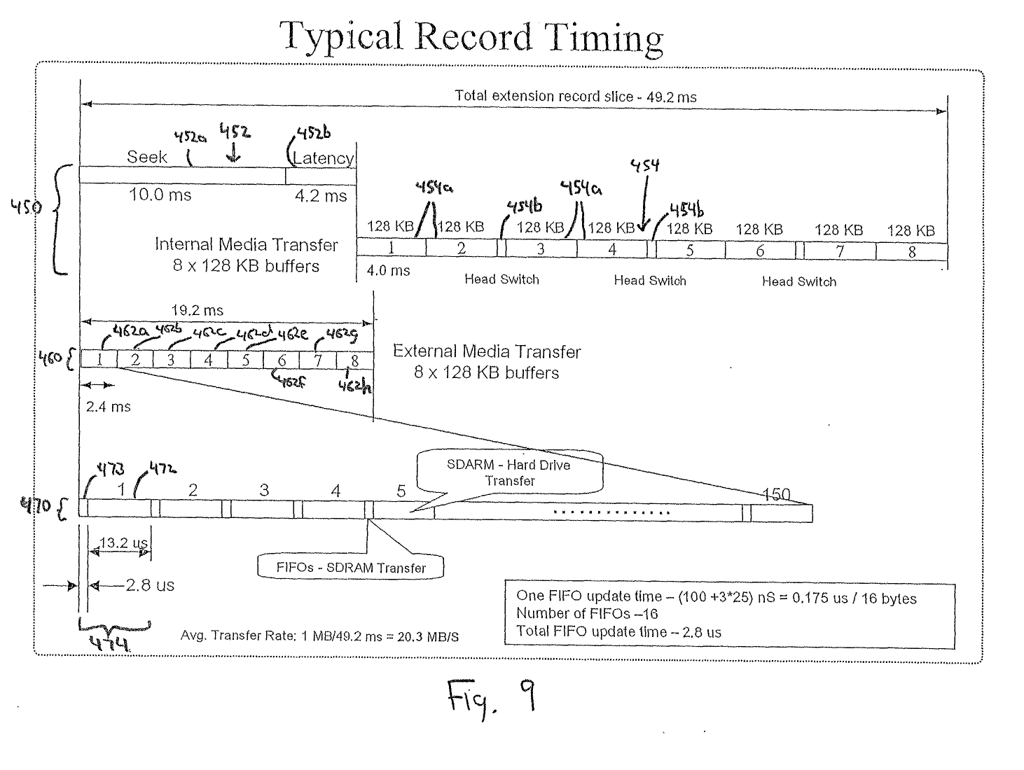

In block 322, the highest priority channel from the “active” channels will be found, and it will be set as the current channel. This process of block 322 is detailed in FIG. 8, to which reference is now made.

In FIG. 8, the process starts at block 323. Upon starting, “active” playback channels are identified and estimations are made of the time remaining until the respective playback media buffer 73a-73d becomes empty, at block 324. For example, this estimation (En, n being the number of the channel) may be made by the following formula:

Eₙ=DS_{OB}/tᵣ (1)

where

DS_{OB} is the size of the occupied portion of the buffer; and

tᵣ is the transfer rate for the specific channel

The resultant estimation Eₙ is the minimum time, that is, the time until the buffer will be empty.

“Active” record channels are then identified, and estimations are made of the time remaining until the respective record media buffer 74a-74d becomes full, at block 325. For example, this estimation (Eₙ) may be made by the following formula:

Eₙ=DS_{UB}/tᵣ (2)

where,

DS_{UB} is the size of the unoccupied potion of the buffer; and tᵣ is detailed above.

The resultant estimation Eₙ is the minimum time, that is, the time until the buffer will be full.

With both “active” playback and record channels identified, the process moves to block 326, where these active channels are analyzed to determine the one with the smallest minimum time. The active channel with the smallest minimum time is determined to be the highest priority channel. With the highest priority channel determined, the process ends at block 327, and returns to block 328 of FIG. 7.

Turning back to FIG. 7, it is then determined if a playback channel is the highest priority, at block 328. If yes, an analysis of the playback buffer for the requisite channel is made to see if the media buffer contains free space that would accommodate more than one slice, here for example, approximately 1 MB of data (as detailed in FIG. 5 above), data, at block 330. If the empty space in the playback media buffer is smaller than one slice (or no), the process returns to block 308. Alternately, if the empty space in the playback media buffer is larger than one slice (or yes), data corresponding to the next program slice on the requisite hard disc of the hard drive 70 is located, at block 332. This is typically accomplished by the querying the slice table for the next table entry.

It is then determined from this next table entry, if a slice is found, at block 334. If the next slice is found, the video data corresponding to this slice is transferred from the requisite hard disc of the hard drive 70 to the playback media buffer 73a-73d, at block 336, and once this step is executed, the process returns to block 308. If not, the requisite channel is set to the “inactive” state, at block 338, whereby the playback has ended, and the process returns to block 308.

Returning to block 328, if a playback channel is not the highest priority channel, an analysis of the record buffer for the requisite channel is made to see if the media buffer is occupied with data of more than one slice, here for example, approximately 1 MB of data (as detailed in FIG. 4 above), data, at block 340. If the data in the record media buffer is smaller than one slice (or no), the process returns to block 308. If the data in the record media buffer is larger than one slice (or yes), the process continues to block 342.

There is a query to find the next free slice on the requisite disc of the hard drive 70, at block 342. This query involves surveying the free slice table 136 of the requisite disc of the hard drive 70 for a free slice in which to place the data corresponding to the record media buffer of this high priority record channel.

The data from the record media buffer corresponding to the high priority channel is then transferred from the requisite media buffer to the free slice in the hard drive (found in block 342), at block 344. With the transfer complete, the free slice table is updated, at block 346. This updating involves returning to the free slice table and marking the once-free slice as occupied. Additionally, the slice table in the program header has the address of the now-occupied slice written into it, for slice identification, at block 348. Once this step is executed, the process returns to block 308.

The process detailed above, all or portions thereof, can be embodied in programmable or program storage devices readable by a machine or the like, or other computer-usable storage medium, including magnetic, optical or semiconductor storage, or other source of electronic signals.

There are also user supplied commands, such as those streaming commands for PAUSE RECORDING, CONTINUE RECORDING, STOP PLAYBACK, PAUSE PLAYBACK and CONTINUE PLAYBACK, that are executed outside of the video switch 62. When these commands are received at the main processor 61, transformed commands, corresponding to requesting channels, are issued to the requisite encoders 66a-66d and decoders 67a-67d.

In the case of a PAUSE RECORDING, the system operates such that the data stream for the requisite channel, from its respective encoder to the video switch is stopped. For example, this could be achieved by the main processor 61, issuing a transformed command, that ultimately stops the requisite encoder. Here, the channel remains “active” and thus, processing is in accordance with the process 300 detailed for the video switch 62, with any data transferred from the requisite data buffer to the requisite hard disc(s) of the hard drive 70, for that channel, in accordance with the process from block 320 onward. Typically, with this PAUSE command, the main processor 61 also issues a command to hardware and software of the server to freeze the picture on screen.

In the case of a CONTINUE RECORDING, the system operates such that the data stream for the requisite channel, from its respective encoder to the video switch is resumed. For example, this could be achieved by the main processor 61 issuing a transformed command, that ultimately restarts the requisite encoder streaming video. Here, the channel remains “active” and thus, processing is in accordance with the process 300 detailed for the video switch 62, with any data transferred from the requisite data buffer to the hard disc(s) of the hard drive 70, for that channel, in accordance with the process 300 from block 320 onward.

In the case of a PAUSE PLAYBACK, the system operates such that the data stream for the requisite channel, from the video switch to its respective decoder is stopped. For example, this could be achieved by the main processor 61 issuing a transformed command, that ultimately stops the requisite decoder. Here, the channel remains “active” and thus, processing is in accordance with the process 300 detailed for the video switch 62, with any data transferred from the hard drive 70 to the requisite data buffer, for that channel, in accordance with the process from block 320 onward. With this PAUSE command, the main processor issues a command to freeze the picture on screen, as detailed above.

The STOP PLAYBACK case is similar to the PAUSE PLAYBACK case, except that the transformed command from the main processor 61, activates hardware and software in the server 20 to switch the video to regular television or another on-screen display, as opposed to the PAUSE, where the picture is frozen.

In the CONTINUE PLAYBACK case, playback the system operates such that the data stream for the requisite channel, from the video switch to its respective decoder is resumed. For example, this could be achieved by the s main processor 61 issuing a transformed command, that ultimately restarts the requisite video stream to the requisite decoder. Here, the channel remains “active” and thus, processing is in accordance with the process 300 detailed for the video switch 62, with any data transferred from the hard disc of the hard drive 70 to the requisite data buffer for that channel is in accordance with the process 300, from block 320 onward.

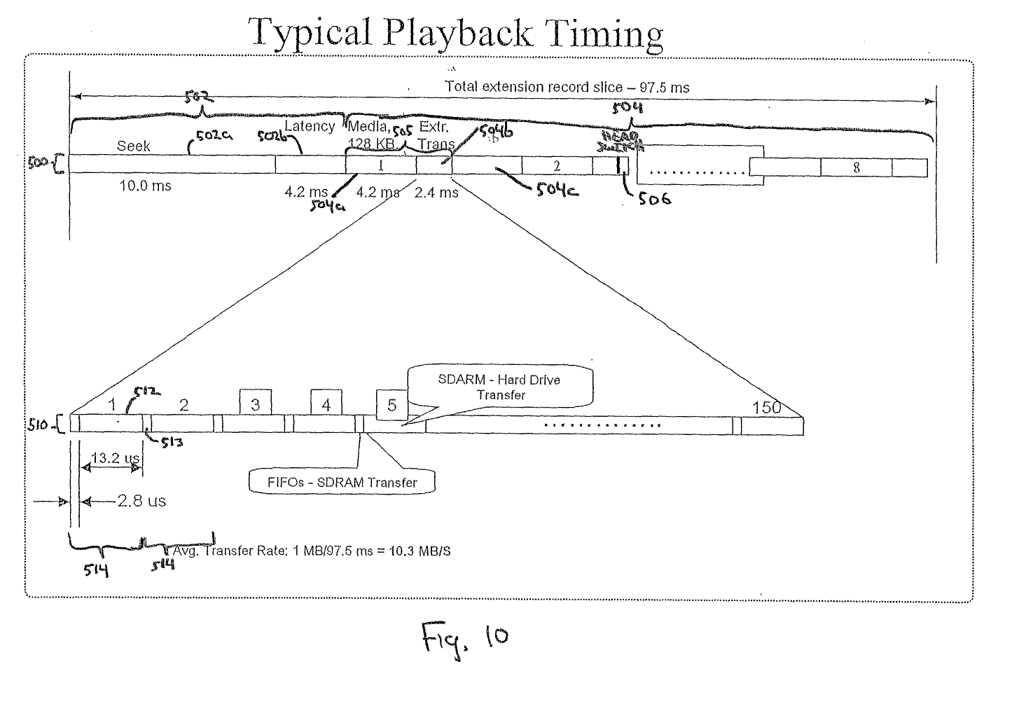

FIG. 9, to which attention is now directed, details an example record or write operation, in a timing diagram. The times detailed below are averages, and with the exemplary calculations based on the hard drive detailed in the Table of FIG. 4. While references are made to components above, this is exemplary only.

This timing diagram is formed of three lines. Line 450 represents the timing of the internal operation of hard drive. Line 460 represents the data transfer between the respective media buffer 74a-74d and buffer of the hard drive 70. Line 470 represents each 128 KB transfer of line 460, in greater detail. As shown in this diagram the processes of lines 450 and 460 are typically performed in parallel.

The timing of the internal operation inside the hard drive 70, where 1 MB of data is written onto the disc(s) of the hard drive 70 is formed of two major steps, represented by segments 452 and 454.

The first step, represented by segment 452 involves a mechanical movement of the drive head, as it moves to the correct position for writing. Specifically, this first step involves a seek operation, to obtain the proper track on the disc, that is typically 10.0 ms long, represented by subsegment 452a. This is followed by a 4.2 ms latency period, to obtain the correct sector within the track, represented by subsegment 452b. Accordingly, the total time for this first step, using for example, the hard drive detailed in FIG. 5, is approximately 14.2 ms.

The second step, represented by segment 454, involves the actual transfer or writing of the data from the hard disc buffer to the track in the hard disc. Typically, data is written (transferred) in 128 KB intervals, represented by subsegments 454a, so as to fill the requisite track of the disc. Each 128 KB transfer typically takes approximately 4.0 ms.

Each time a track is filled, regardless of the actual point in the present 128 KB transfer, there is a head switch, or a track to track seek operation, to reach the next suitable track. This head switch or track to track seek operation typically takes approximately 1.0 ms, and is represented by subsegments 454b. After the head switch or track to track seek operation is complete, the 128 KB transfer continues as detailed above. For example, with the hard drive of FIG. 5, there are typically two consecutive 128 KB transfers, followed by a head switch or track to track seek operation, whereby this second step is approximately 35.0 ms.

With respect to line 460, the process of writing or transferring 1 MB from the media buffer 74a-74d, to the internal buffer of the disk drive 70, typically involves eight transfers of 128 KB, with each transfer being approximately 2.4 ms, as represented by subsegments 462a-462h. Accordingly, the total transfer time for this process is approximately 19.2 ms.

The process for each of the aforementioned eight transfers will now be described for a single transfer, for example subsegment 462a, represented by line 470.

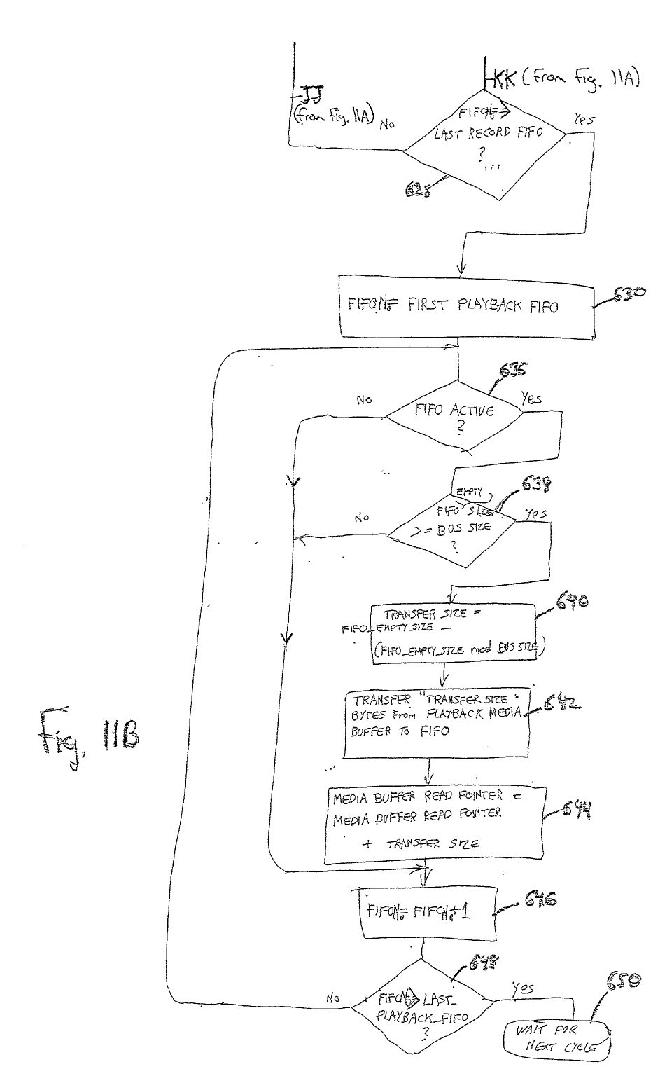

Line 470, corresponds to a 128 KB direct memory access (DMA) transfer, from the media buffer 74a-74d to the drive internal buffer. Since FIFO's 100a-100d, have a higher priority than the DMA transfers themselves, represented by subsegments 472, these DMA transfers are interrupted by FIFO transfers, represented by subsegments 473, every approximately 16.0 microseconds, represented by segments 474. Each interruption, represented by segments 473, typically takes approximately 2.8 microseconds (μs). During this interruption, all transfers to or from all FIFO buffers 100a-100d take place in accordance with the process shown in FIGS. 11A and 11B, and detailed below.

In the remaining 13.2 μs, represented by subsegments 472, the DMA transfer proceeds. For example, in accordance with the hard drive detailed in FIG. 5 above, 871 bytes of data are transferred in each 13.2 μs subsegment 472. This results in approximately 151 segments 474, each segment 474 being approximately 16.0 μs. Accordingly, the total time for transferring this 128 KBs, represented by segment 462a, is approximately 2.4 ms. This is repeated seven more times, so as to transfer 7×128 KB, represented by segments 462b-462h.

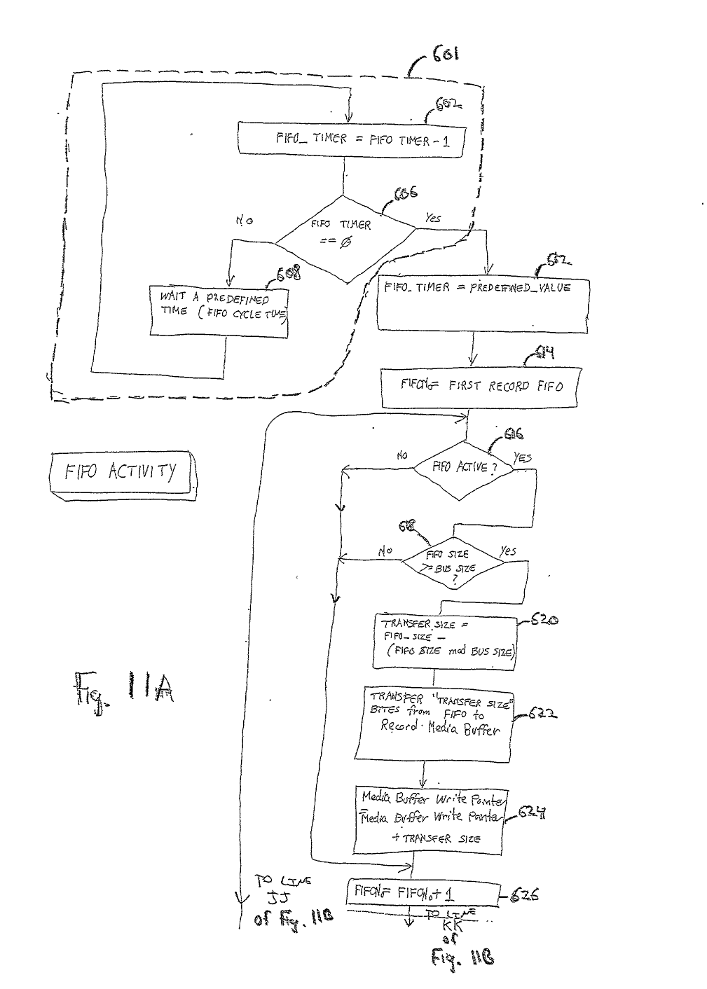

FIG. 10, to which attention is now directed, details an example playback or read operation, in a timing diagram. The times detailed below are averages, and with the exemplary calculations based on the hard drive detailed in the Table of FIG. 5. While references are made to components above, this is exemplary only.

This timing diagram is formed of two lines. Line 500 represents the timing of all playback operations for the hard drive. Line 510 represents the transfer of data from the hard drive data buffer to the media buffers 73a-73d in detail. As shown in this diagram, the processes of reading data from the hard disc and its transfer to the respective media buffer is typically performed serially.

The timing of the internal operation inside the hard drive 70, where 1 MB of data is read from the disc(s) of the hard drive 70 is formed of two major steps, represented by segments 502 and 504.

The first step, represented by segment 502 involves a mechanical movement of the drive head, as it moves to the correct position for reading. Specifically, this first step involves a seek operation, to obtain the proper track on the disc, that is typically approximately 10.0 ms long, represented by subsegment 502a. This is followed by an approximately 4.2 ms latency period, to obtain the correct sector within the track, represented by subsegment 502b. Accordingly, the total time for this first step, using for example, the hard drive detailed in FIG. 4, is approximately 14.2 ms.

The second step, represented by segment 504, involves the actual transfer or reading of the data from the track in the hard disc (of the hard drive 70) to the hard disc buffer, and then transferring this data to the respective media buffer 73a-73d. Typically, data is read (transferred) in 128 KB intervals, represented by subsegments 504a, from the requisite track of the disc to the buffer of the hard drive. Each 128 KB transfer typically takes approximately 4.2. ms. This is followed by a transfer of data from the disc internal buffer to the respective media buffer 73a-73d, represented by subsegment 504b, that is approximately 2.4 ms. These two aforementioned operations (represented by subsegments 504a and 504b) define a single “read” operation, as represented by the bracket 505. This read operation is followed by a latency period, represented by subsegment 504c, that is approximately 4.2 ms.

During transfer of data from the hard disc track to the hard disc internal buffer (of the hard drive 70), regardless of the actual point in the present 128 KB transfer, there can be a head switch, or a track to track seek operation, to reach the next suitable track for reading. This head switch or track to track seek operation typically takes approximately 1.0 ms, as represented by subsegment 506. After the head switch or track to track seek operation is complete, the 128 KB transfer continues, as detailed above.

This read operation, followed by the latency period, continues seven more times, and providing for head switches or track to track seek operations in accordance, for example, with the hard disc of FIG. 4, the second step, represented by segment 504, will be for approximately 83.3 ms.

The process for each of the aforementioned eight transfers will now be described for a single transfer, for example subsegment 504b, represented by line 510.

Line 510, corresponds to a 128 KB direct memory access (DMA) transfer, from the drive internal buffer to the media buffer 74a-74d. Since FIFO's 100a-100d, have a higher priority than the DMA transfers themselves, represented by subsegments 512, these DMA transfers are interrupted by FIFO transfers, represented by subsegments 513, every approximately 16.0 microseconds, represented by segments 514. Each interruption, represented by segments 513, typically takes approximately 2.8 microseconds (μs). During this interruption, all transfers to or from all FIFO buffers 100a-100d take place in accordance with the process shown in FIGS. 11A and 11B and detailed below.

In the remaining 13.2 μs, represented by subsegments 512, the DMA transfer proceeds. For example, in accordance with the hard drive detailed in FIG. 5 above, 871 bytes of data are transferred in each 13.2 μs subsegment 512. This results in approximately 151 segments 514, each segment 514 being approximately 16.0 μs. Accordingly, the total time for transferring this 128 KBs, represented by segment 504b, is approximately 2.4 ms.

Each transfer cycle involves activity of the FIFO Buffers 100a-100d and 101a-101d. The operation of the FIFO buffers is detailed in the flow diagram of FIGS. 11A and 11B.

Initially, a process, represented by broken line block 601, is performed where a new or next cycle begins, when the FIFIO timer is at 0. This typically occurs, for example, every 16.0 μs.

Initially, the process of block 601 begins as the FIFO timer is decremented by “1”, at block 602. It is then determined if the FIFO timer is equal to “0”, at block 606. If no, the system waits a predefined cycle time, at block 608, and returns to block 602.

If yes, the FIFO timer is assigned a predefined value, at block 612. The actual FIFO buffer, is now designated a position, these positions typically corresponding to the positions (here, for example, in alphabetical order) taken by FOFOs 100a-100d (for the recording FIFOs), referred to as FIFONO, identifying it as the first Recording FIFO, at block 614. It is now determined if this FIFO is active, at block 616. If the FIFO is not active, it is incremented by “1” at block 626.

If the FIFO is active, a comparison is made to see if FIFO size is greater than or equal to Bus Size, at block 618. If it is not, the process moves to block 626. If it is, a transfer size is calculated by the FIFO size minus the FIFO and modular Bus sizes, at block 620. Bytes are then transferred from the FIFO to the record media buffer, at block 622. The media buffer write pointer is then incremented by adding the media buffer write pointer and the transfer size, at block 624, and the FIFONO is then incremented by “1”, for going to the next FIFO, at block 626.

A check is then made to see if the FIFONO is the last recorded FIFO, at block 628. If no, the process returns to block 616. If yes, it is determined that this FIFO is the first playback FIFO, at block 630.

It is now determined if this FIFO is active, at block 636. If the FIFO is not active, it is incremented by “1” at block 646.

If the FIFO is active, a comparison is made to see if FIFO free space is greater than or equal to Bus Size, at block 638. If it is not, the process moves to block 646. If it is, a transfer size is calculated by the FIFO free space size minus the FIFO modular and Bus sizes, at block 640. Bytes are then transferred from the playback media buffer to the FIFO, at block 642. The media buffer read pointer is then incremented by adding the media buffer read pointer and the transfer size, at block 644, and the FIFONO (similar to that detailed above, each playback FIFO is assigned a position, these positions typically corresponding to the positions taken by FOFOs 101a-101d, here for example, in alphabetical order) is then incremented by “1”, at block 646.

A check is then made to see if the FIFONO is the last playback FIFO, at block 648. If no, the process returns to block 636. If yes, it is determined that this FIFONO is the last playback FIFO, and the system waits for the next cycle at block 650 (in accordance with block 601 above).

The data transfer method described above as employed with the video switch detailed above result in data transfers, typically bidirectional, with guaranteed bandwidth for each of the nodes 30. This guaranteed bandwidth can be, for example, up to 16 Mbps for each direction per node, as may be the case with, for example, MPEG.

The video switch, and systems supporting its operation have been shown and described above were for a four channel operation. This is for example purposes only, as any number of channels is permissible, as configurations supporting any number of single or multiple channel arrangements can be made in accordance with the principles of the invention detailed above.

The methods, processes, apparatus and systems disclosed herein have been described with exemplary reference to specific hardware and/or software. The methods and processes have been described as exemplary, whereby specific steps and their order can be omitted and/or changed by persons of ordinary skill in the art to reduce embodiments of the present invention to practice without undue experimentation. The apparatus and systems include components and arrangements thereof, that have been described as exemplary. The methods, processes, apparatus and systems have been described in a manner sufficient to enable persons of ordinary skill in the art to readily adapt other commercially available hardware and software as may be needed to reduce any of the embodiments of the present invention to practice without undue experimentation and using conventional techniques.

While preferred embodiments of the present invention have been described, so as to enable one of skill in the art to practice the present invention, the preceding description is intended to be exemplary only. It should not be used to limit the scope of the invention.

What is claimed is:

1. A media transfer apparatus comprising:
at least one storage device; and
a controller configured for bidrectionlly transferring video data between a plurality of nodes and said at least one storage device.

2. The media transfer apparatus of claim 1, wherein said at least one storage device includes a hard drive unit.

3. The media transfer apparatus of claim 1, wherein said controller comprises:
a first subcontroller configured for regulating transfer of data flows defining said video data;
a processor in communication with said first controller for communicating instructions to said first controller; and
a second subcontroller configured for controlling said transfers between said first subcontroller and said at least one storage device.

4. The media transfer apparatus of claim 3, wherein said at least one storage device includes a hard drive unit.

5. The media transfer apparatus of claim 3, wherein said processor includes a RISC processor.

6. The media transfer apparatus of claim 3, wherein said second subcontroller includes an ATA controller.

7. The media transfer apparatus of claim 3, additionally comprising at least one buffer in communication with said controller.

8. The media transfer apparatus of claim 3, wherein said controller additionally comprises: a plurality of paired FIFO buffers, each of pair of FIFO buffers corresponding to one of said plurality of nodes.

9. The media transfer apparatus of claim 8, additionally comprising an encoder in communication with one FIFO of said paired FIFOS and a decoder in communication with said other FIFO of said paired FIFOS.

10. The media transfer apparatus of claim 8, wherein at least one of said nodes is configured for receiving and sending signals corresponding to either of the playing or recording of video data.

11. The media transfer apparatus of claim 8, wherein at least one of said nodes is configured for supporting a workstation.

12. A data transfer system comprising:
a system residing on at least one chip, said system configured for bidrectionlly transferring digital media data between a plurality of nodes and at least one storage media.

13. The data transfer system of claim 12, wherein said at least one chip is a Very Large Scale Integration (VLSI) device.

14. The data transfer system of claim 13, additionally comprising, a storage media buffer, and said VLSI device is configured for performing said bidirectional digital media data transfers with said storage media buffer.

15. The multichannel media transfer device of claim 12, additionally comprising at least one storage media.

16. The data transfer system of claim 13, wherein said at least one chip includes one chip.

17. The data transfer system of claim 13, wherein said VLSI device is additionally configured for real time multichannel recording of independent video streams onto said single hard drive unit and real time multichannel playback of independent video streams from said hard drive unit, said recording and playback being at least contemporaneous in time.

18. The data transfer system of claim 13, wherein said VLSI device includes:
a controller configured for regulating transfer of said digital media data;
a processor in communication with said controller for communicating instructions to said controller; and
a storage media interface configured for controlling said transfers between said controller and said at least one storage media.

19. The data transfer system of claim 18, wherein said processor includes a RISC processor.

20. The data transfer system of claim 13, wherein said VLSI device additionally comprises: a plurality of paired FIFO buffers, each of pair of FIFO buffers for correspondence with one of said plurality of nodes.

21. The data transfer system of claim 12, wherein said digital media data is selected from the group comprising: video data, audio data or combinations thereof.

22. A method for transferring video data between plurality of nodes corresponding to channels, and at least one storage device, comprising:
monitoring at least one cue for entry of at least one predetermined command;
activating at least one of said plurality of channels in accordance with said at least one predetermined command being entered, and
if said at least one predetermined command has not been entered,
determining if at least one channel is active; and
if at least one channel is active, transferring video data on said at least one active channel.

23. The method of claim 22, wherein said transferring video data on said at least one active channel comprises:
determining the highest priority channel of said at least one active channel;
performing at least one video data transfer operation in accordance with the activity of said highest priority channel.

24. The method of claim 23, wherein said activity includes at least one of playback or recording.

25. A method for transferring video data to and from at least one hard disc comprising:
dividing said at least one hard disc into slices, said slices either occupied with data or free of data; and
performing a playback operation for a predetermined recorded segment, comprising:
locating a slice of said stored data corresponding to said predetermined recorded segment;
transferring said at least one slice of said stored data from said hard disc; or
performing a record operation comprising:
locating a slice free of data;
transferring a portion of said recorded data to said slice free of data.

26. The method of claim 25, additionally comprising:
creating a table of said slices free of data and updating said table of free slices when said portion of said recorded data has been transferred to slice free of data.

27. A hard disc comprising:
a first area and a second area;
said first area comprising a plurality of divisions configured for being occupied with portions of video data;
said second area including at least one division defining a table for said divisions of said first area not occupied with portions of video data.

28. The hard disc of claim 27, wherein said first area defines a video data storage area and said second area defines a management area.

29. The hard disc of claim 28, wherein said divisions are configured for storing portions of video data.

30. The hard disc of claim 28, wherein said second area comprises a plurality of divisions, said plurality of divisions including data storage for the group comprising: settings, program categories, users and disc headers.

31. A data transfer system comprising:
a controller configured for supporting multiple nodes and configured for providing an interface to centralized storage, said controller including switched architecture for supporting bidirectional data streaming between said multiple nodes and said centralized storage.

32. The data transfer system of claim 31, additionally comprising multiple nodes on communication with said controller.

33. The data transfer system of claim 31, additionally comprising centralized storage.

34. The data transfer system of claim 33, wherein said centralized storage includes at least one storage media.

35. The data transfer system of claim 34, wherein said at least one storage media includes a hard drive unit.

36. A data transfer system comprising:
a plurality of channels;
a server comprising:
a port for receiving data from at least one data source;
a controller interfaced to said port and configured for interfacing with centralized storage, said controller configured for supporting at least one of; a) recording of said received data to said centralized storage; and b) playback of recorded data from said centralized storage, over each of said channels.

37. The data transfer system of claim 36, wherein said at least one of; a) recording of said received data to said centralized storage; and b) playback of recorded data from said centralized storage, over each of said channels is performed independently for each of said channels.

38. The data transfer system of claim 36, wherein said at east one of; a) recording of said received data to said centralized storage; and b) playback of recorded data from said centralized storage includes both (a) and (b).

39. The data transfer system of claim 36, wherein said channels are accessible by nodes.

40. The data transfer system of claim 36, wherein said centralized storage includes at least one storage media.

41. The data transfer system of claim 40, wherein said at least one storage media includes a hard drive unit.

42. A data transfer system comprising:
a controller configured for interfacing with centralized storage and access from any of a plurality of nodes upon receiving at least one signal from one node of said plurality of nodes, said controller configured for facilitating data transfer between said nodes and said centralized storage upon said receiving at least one signal from at least one node of said plurality of nodes.

43. The data transfer system of claim 42, wherein said configuration for data transfer includes configuration for bidirectional data transfer between said nodes and said centralized storage.

44. The data transfer system of claim 43, wherein said bidirectional data transfer includes media streaming.

45. The data transfer system of claim 43, additionally comprising, a plurality of nodes in communication with said controller.

46. The data transfer system of claim 42, wherein said centralized storage includes at least one storage media.

47. The data transfer system of claim 46, wherein said at least one storage media includes a hard drive unit.

48. A data transfer device comprising:
a system residing on at least one chip, said system configured for bidrectionlly transferring digital media data between a plurality of nodes and at least one storage media.

49. The data transfer device of claim 48, wherein said at least one chip is a Very Large Scale Integration (VLSI) device.

50. The data transfer device of claim 49, wherein said VLSI device is configured for performing said bidirectional digital media data transfers with a storage media buffer.

51. The data transfer device of claim 48, wherein said at least one chip includes one chip.

52. The data transfer device of claim 49, wherein said VLSI device is additionally configured for real time multichannel recording of independent video streams onto said single hard drive unit and real time multichannel playback of independent video streams from said hard drive unit, said recording and playback being at least contemporaneous in time.

53. The data transfer device of claim 49, wherein said VLSI device includes:
a controller configured for regulating transfers of said digital media data;
a processor in communication with said controller for communicating instructions to said controller; and
a storage media interface configured for controlling said transfers between said controller and said at least one storage media.

54. The data transfer device of claim 53, wherein said processor includes a RISC processor.

55. The data transfer device of claim 49, wherein said VLSI device additionally comprises: a plurality of paired FIFO buffers, each of pair of FIFO buffers for correspondence with one of said plurality of nodes.

56. The data transfer device of claim 48, wherein said digital media data is selected from the group comprising: video data, audio data or combinations thereof.
